(19) United States
(12) Patent Application Publication
(10) Pub. No.: US 2002/0052225 A1
(43) Pub. Date: May 2, 2002

(54) Feature timer functionality for a wireless communication unit

(76) Inventors: Derek L. Davis, Phoennix, AZ (US); William W. Schaal, Irvine, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/021,154

(22) Filed: Oct. 30, 2001

Related U.S. Application Data
(63) Continuation-in-part of application No. 09/866,211, filed on May 26, 2001.
(60) Provisional application No. 60/244,612, filed on Nov. 1, 2000.

(51) Int. Cl. H04B 1/38; H04M 1/00

(52) U.S. Cl. 455/567; 455/575

(57) ABSTRACT

In one embodiment, a calendar program is loaded and stored internally within a wireless communication unit. The calendar program is accessed in order to schedule an occurrence of a first event using the calendar program. The first event may cause activation or deactivation of a first operating mode for the wireless communication unit. Such activation or deactivation may occur for a specified period of time.

This application is a continuation-in-part application of U.S. patent application Ser. No. 09/866,211, which is based on U.S. Provisional Patent Application No. 60/244,612, filed on Oct. 30, 2000.

### FIELD

The invention relates to the field of wireless communications. More specifically, various embodiments of the invention relate to a wireless communication unit and method that supports deactivation and/or activation of a particular mode of operation.

### GENERAL BACKGROUND

Wireless communications have dramatically improved business productivity and personal safety. In particular, cellular telephones now enable business employees to stay in contact with other employees, suppliers and even customers, especially in locations where normal plain old telephone system (POTS) communications are inconvenient. Also, they enable persons in distress to communicate with law enforcement and emergency technicians.

Unfortunately, as with many emerging technologies, cellular telephones may present a variety of disadvantages. For example, cellular telephones can be disruptive to public private gatherings such as business meetings or presentations, concerts, theater plays or other events at public venues. For these and other similar situations, in the past, cellular telephone users have been asked, or feel obligated, to temporarily deactivate their telephones. This requires the user to later remember to reactivate the cellular telephone.

Upon realizing this disadvantage, certain manufacturers now offer cellular telephones with a “silent” ring mode, which initiates a pager-like vibration to notify the cellular telephone user of an incoming call. Nevertheless, the user may still need or desire to answer the phone to confirm that the incoming call is not an emergency. In other words, while placing the cellular telephone in a silent ring mode can avoid the presence of a distracting, audible ring, it does not prevent the inevitable disruption created when the user answers the cellular telephone to receive the incoming call. This disruption can be a sudden flurry of activity by the user to retrieve his or her cellular telephone and/or audible statements by the user despite his or her attempts to suppress or conceal the conversation.

Another disadvantage involves the use of cellular telephones while driving. Simply stated, the driver may not fully appreciate the surrounding traffic and road conditions when dialing a cellular telephone or talking on the cellular telephone. The additional activity impairs his or her ability to drive safely, which can lead to an automobile accident that injures the user or others. Furthermore, if the cell phone user was engaged on behalf of a company at the time of the call and accident, either calling during work hours or calling to conduct company business, liability may be passed through to the company.

Yet another disadvantage is that, within sensitive environments, cellular telephones must be deactivated. For example, during air travel, all cellular telephones must be turned off because such use may interfere with flight communications or navigational equipment. Also, many hospitals require cellular telephones to be turned off because such use may interfere with diagnostic equipment. When the user departs from a sensitive environment, he or she often forgets to reactivate the cellular telephone and return it to its normal operating mode. As a result, the user occasionally fails to receive an urgent or important call. BRIEF

### DESCRIPTION OF THE DRAWINGS

The features and advantages of the invention will become apparent from the following detailed description of the invention in which:

FIG. 1A is a first exemplary embodiment of a wireless system.

FIG. 1B is a second exemplary embodiment of a wireless system.

FIG. 2A is a first exemplary embodiment of exterior elements of a wireless communication unit employed within a wireless system of at least one of FIGS 1A and 1B.

FIG. 2B is a second exemplary embodiment of exterior elements of a wireless communication unit employed within the wireless system of at least one of FIGS. 1A and 1B.

FIG. 3A is a first exemplary embodiment of internal logic of the wireless communication unit of at least one of FIGS. 2A and 2B.

FIG. 3B is a second exemplary embodiment of internal logic of the wireless communication unit of at least one of FIGS. 2A and 2B.

FIGS. 4A-4B are exemplary operations of a date/time scheduler of FIG. 3A to control activation of various events by the wireless communication unit.

FIGS. 5A-5M are exemplary image screens of an embodiment for scheduling one or more feature timer events at the wireless communication unit or service provider.

FIG. 6 is a first exemplary flowchart of the Pickup Pause feature performed by the wireless communication unit of at least one of FIGS. 2A and 2B.

FIG. 7 is a second exemplary flowchart of the Pickup Pause feature performed by the wireless communication unit of at least one of FIGS. 2A and 2B.

FIG. 8 is an exemplary flowchart describing a first enhancement of the Pickup Pause feature performed by the wireless communication unit of at least one of FIGS. 2A and 2B.

FIG. 9 is an exemplary flowchart describing a second enhancement of the Pickup Pause feature performed by the wireless communication unit of at least one of FIGS. 2A and 2B.

FIG. 10 is an exemplary flowchart describing a third enhancement of the Pickup Pause feature performed by the wireless communication unit of at least one of FIGS. 2A and 2B.

### DETAILED DESCRIPTION

In general, one embodiment of the invention relates to a wireless communication unit, operating at least in part as a cellular telephone, that is programmable to switch to a selected mode of operation and perhaps return to another mode of operation after a period of time has elapsed. Another embodiment of the invention refers to a mechanism for communicating the amount of time that the wireless communication unit will be inactive to a source of an incoming call to avoid unnecessary redials.

Herein, certain terminology is used to discuss features of the invention. For example, the term “user” or “recipient” is intended to refer to the operator of a wireless communication unit that receives information over a wireless connection. A “wireless connection” involves the usage of one or more communication channels, which enable information transmitted from a caller at a remote source to be perceived by the user of the wireless communication unit and vice versa. For instance, the information may include audio in accordance with a given format (e.g., digital or analog) and at given frequency range such as cellular, Personal Communication Systems (PCS), microwave, or satellite.

A “wireless communication unit” is intended to refer to any device capable of establishing a wireless connection with another device. One embodiment of a wireless communication unit includes a cellular telephone, although other types of products may apply such as an alphanumeric pager for example. The wireless communication unit may be placed in a number of operating modes involving power, ring type or the like.

For instance, when placed in a “Power-Off” mode, the wireless communication unit neither receives nor processes information associated with an incoming call, nor does it transmit signals of any kind. For instance, the Power-Off mode may be realized by disconnecting power supplied to a transceiver or other component(s) employed within the wireless communication unit. When placed in a “Suspend Power-Off” mode, the wireless communication unit receives but fails to process information associated with an incoming call.

Generally, “software” is defined as one or more instructions that when executed, cause the wireless communication unit to perform a certain function or operation. The instructions are stored in machine-readable medium, which is any medium that can store and transfer information. Examples of machine-readable medium include, but are not limited to an electronic circuit, a semiconductor memory device (volatile or non-volatile), a data storage disk (e.g. mechanical or optical hard drive) or even any portable storage media such as a diskette, a disc, tape, card and like. The machine-readable medium may further include an information-carrying medium such as electrical wire, optical fiber, cable, bus, air in combination with wireless signaling technology or any combination thereof.

I. System Architecture

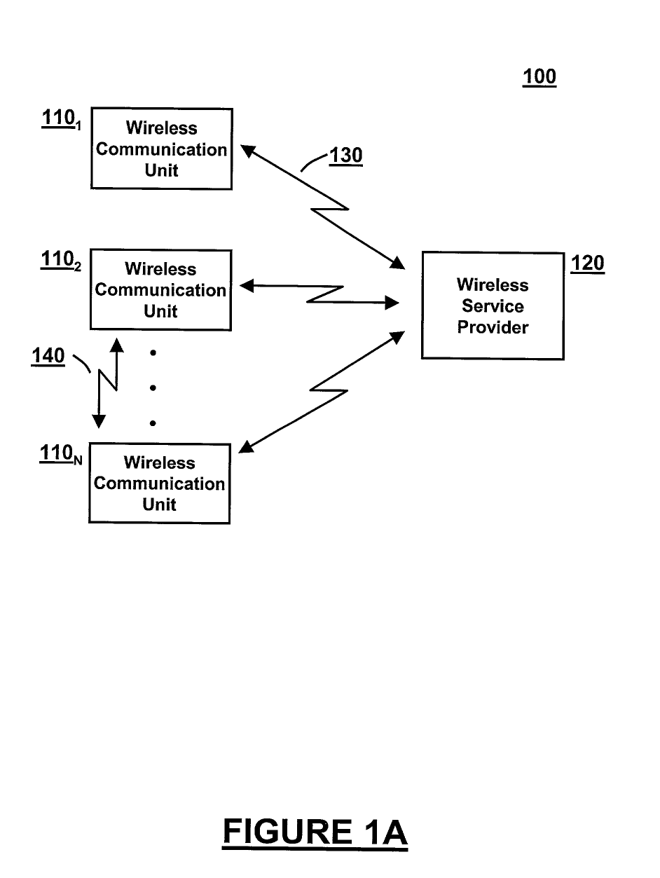

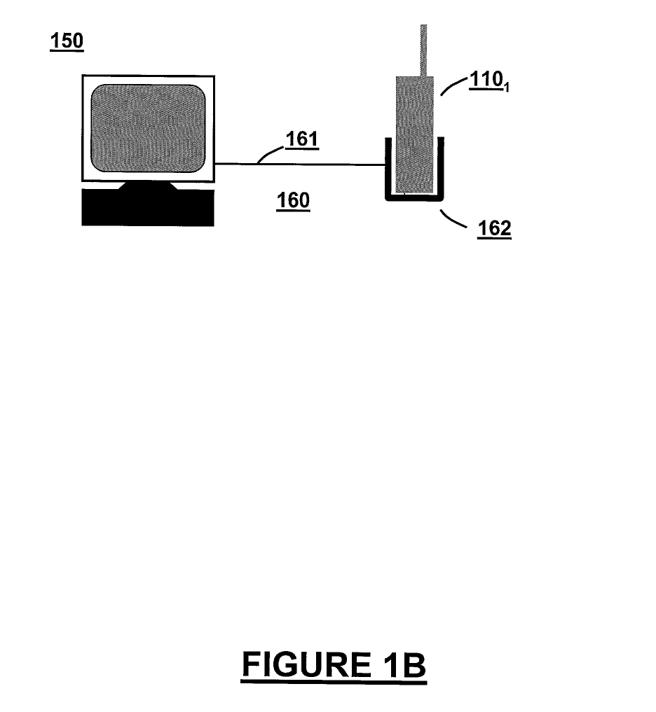

Referring to FIGS. 1A and 1B, exemplary embodiments of a wireless system 100 is shown. For one embodiment, as shown in FIG. 1A, wireless system 100 comprises a plurality (N) of wireless communication units 110₁-110_{N} (where N≧1). These wireless communication units 110₁-110_{N} may communicate directly with each other (e.g., wireless connection 140) and/or indirectly through a wireless service provider 120 over wireless connection 130 as shown. Examples of service provider 120 include any base station or tower of a commercial cellular telephone company, satellites such as those employed by the former Iridium system, or even a base station serving one or more wireless communication units within a residence.

It is contemplated, however, that one or more of wireless communication units 110₁-110_{N} may communicate with a device supporting both wired and wireless communications. For example, the device may support a wireless connection but is coupled to a wired bus (e.g., a wide local area network “WLAN” station).

Moreover, as shown in another embodiment of FIG. 1B, wireless communication unit 110₁ may be placed in communication with a computer 150 over a dedicated communication pathway 160. The computer 150 may be a desktop, laptop, hand-held (e.g., personal digital assistant “PDA”), server, a television set-top box and the like.

In one embodiment, communication pathway 160 may be represented by a dedicated physical medium such as a cable 161 with an interface 162 for wireless communication unit 110₁. Interface 162 could be adapted as a cradle (as shown) or simply a connector adapted to connect to one or more communication ports of wireless communication unit 110₁. The connector may be a serial, parallel, Universal Serial Bus (USB) or other type of connector.

In another embodiment, communication pathway 160 may be represented by wireless signaling directly between wireless communication unit 110₁ and computer 150 (or its peripheral) This wireless signaling may include, for example, infrared pulse(s) or even radio frequency (RF) signals in accordance with BLUETOOTH™, HyperLan, HyperLan/2 or any other current or future wireless communication signaling protocol.

As shown, wireless communication unit 110₁ is able to download information from computer 150 as well as upload information to computer 150. This information may include data associated with an electronic calendar program loaded on computer 150 as well as other types of data or programs.

II. Wireless Communication Unit Architecture

A. Exemplary Handset Architecture

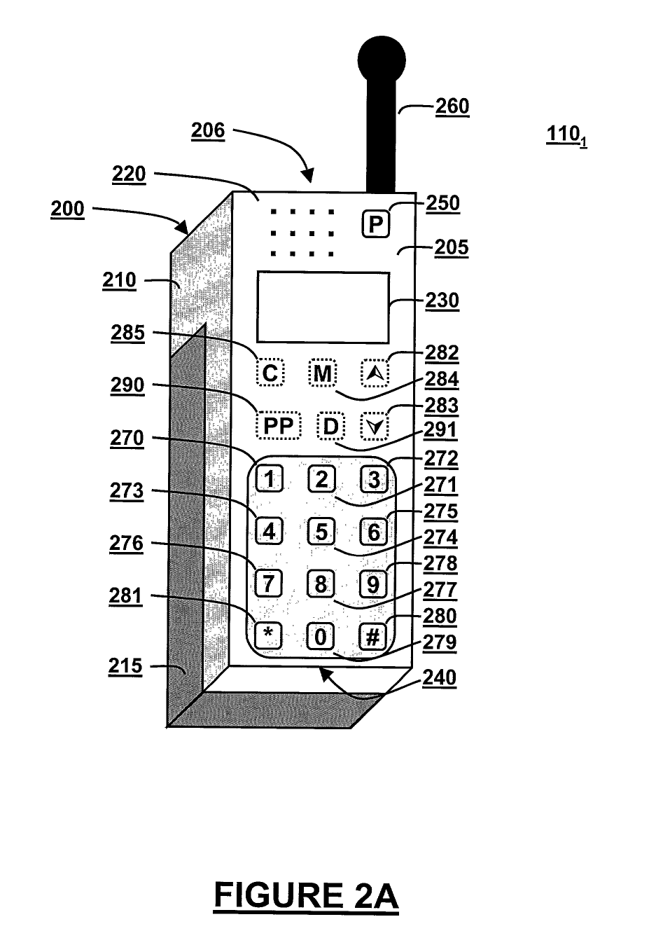

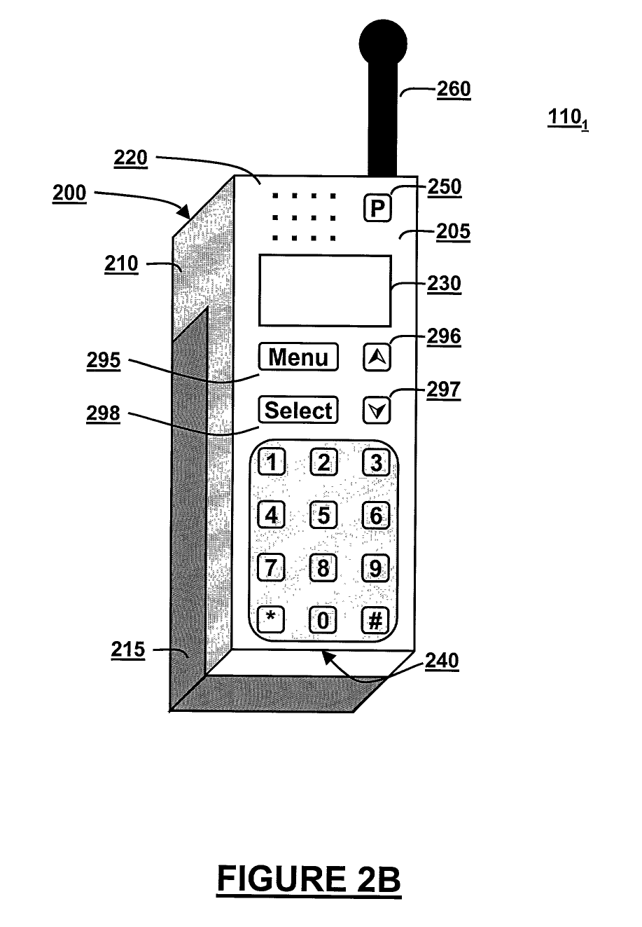

Referring now to FIG. 2A, a first exemplary embodiment of exterior elements of wireless communication unit 110₁ is shown. Wireless communication unit 110₁ comprises a handset casing 200 made of a semi-rigid material such as hardened plastic. Handset casing 200 features both a front face 205 and a back face 210. Back face 210 includes power connectors (not shown) protruding therefrom. These power connectors establish an electrical coupling with a battery 215. In this embodiment, battery 215 is removable. However, it is contemplated that battery 215 may be permanently coupled if recharging may be accomplished while coupled to wireless communication unit 110 or no recharging is necessary.

Front face 205 includes a set of apertures 220, a display 230, a keypad 240, a power button (P) 250, an antenna 260 and optional “PAUSE” (PP) and/or “DEACTIVATE” (D) buttons 290 and 291 as represented by dotted lines.

The apertures 220 are in close proximity to a speaker encased by handset casing 200. These apertures 220 enable the user to more clearly hear audible sounds such as dial tones, ringer tones, or audio associated with incoming wireless signals. For instance, the set of apertures 220 is placed near at a top end 206 of front face 205 as shown.

As further shown in FIG. 2A, display 230 is a liquid crystal display that provides a visual interface for a user to schedule events on wireless communication unit 110₁. In one embodiment, such scheduling may be accomplished by depressing various buttons associated with keypad 240. Keypad 240 includes a standard set of single digit number buttons (0-9) 270-279 as well as various symbol buttons “#” and “*” buttons 280 and 281. Optional keypad buttons include a forward-scroll button 282, a backward-scroll button 283, a menu (M) button 284, a CLEAR (C) button 285 or any combination thereof. Of course, where display 230 is a touch screen, scheduling may be handled using the display 230, thereby eliminating the need for a keypad 240. When using an electronic calendar program, scheduling of events on wireless communication unit 110₁ may be accomplished by updating the user's schedule on a computer and downloading into internal memory of the wireless communication unit 110₁.

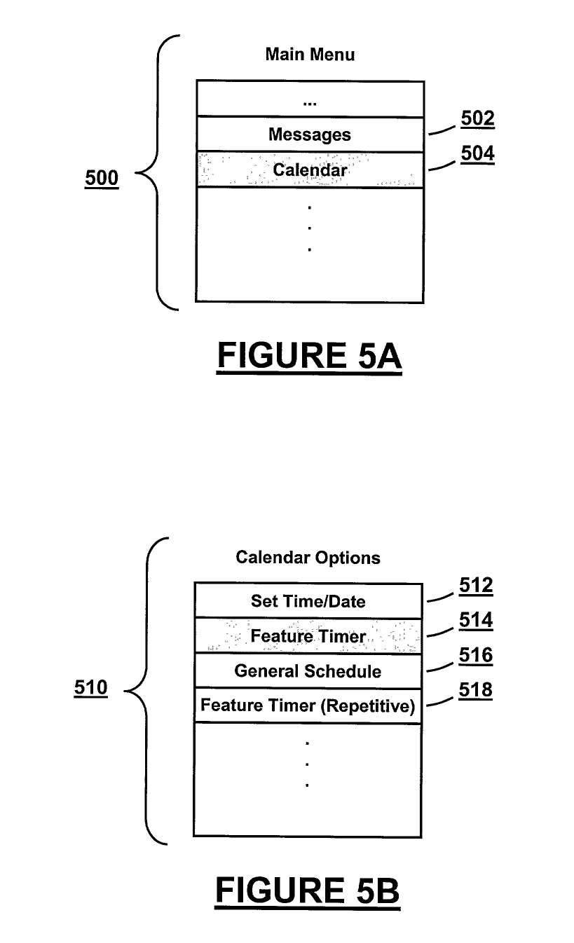

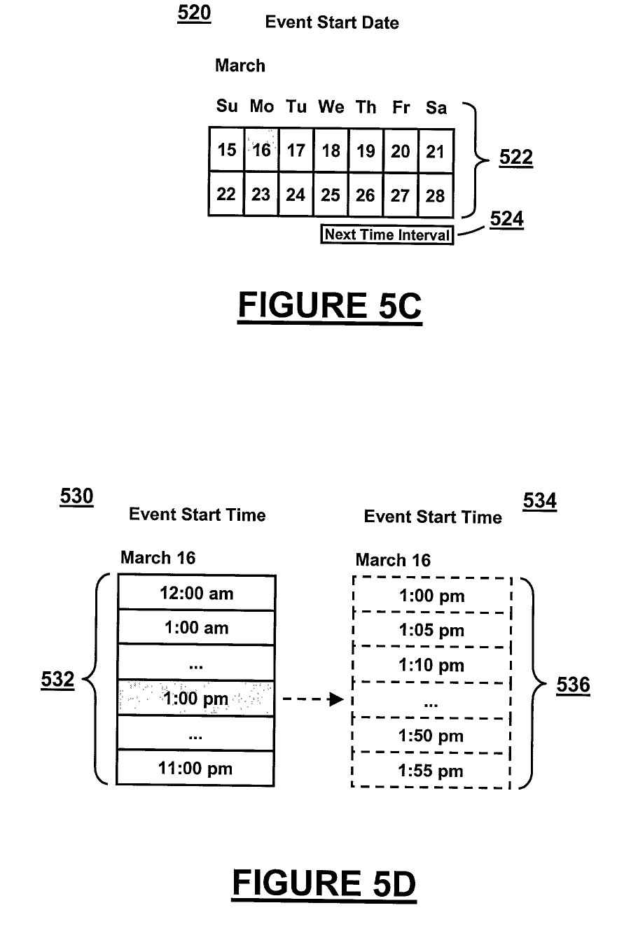

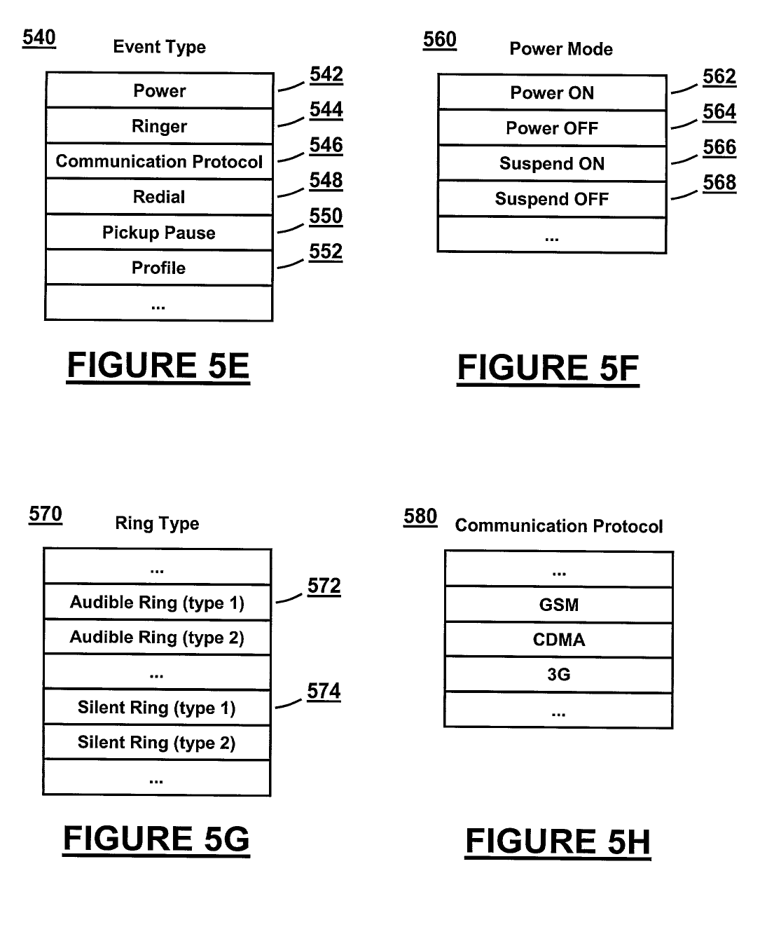

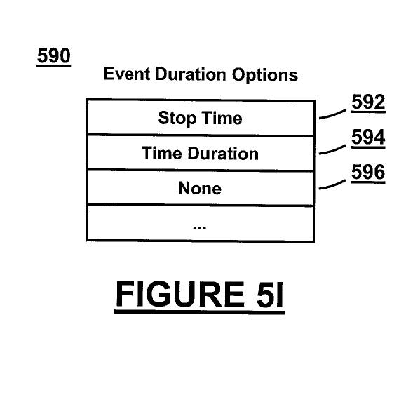

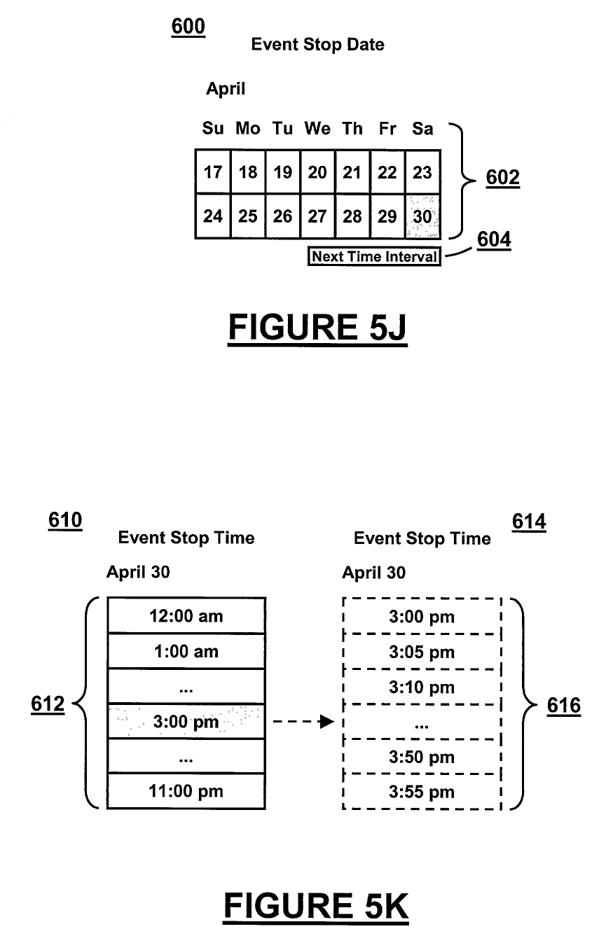

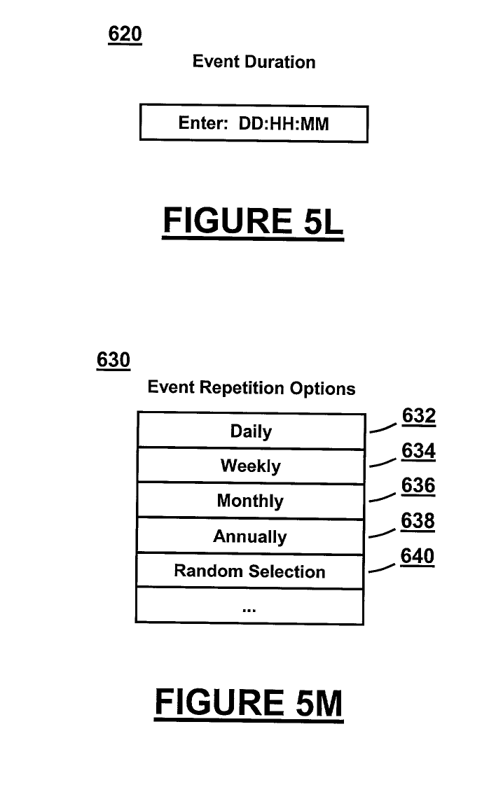

As shown, PAUSE button 290 may be placed on front face 205 of handset casing 200 along with the apertures 220, display 230 and keypad 240. Depression of PAUSE button 290 places wireless communication unit 110₁ into a “Pickup Pause” operating mode; namely, wireless communication unit 110₁ performs Pickup Pause functions as described below. However, it is contemplated that PAUSE button 290 may be placed along a side of handset casing 200 or eliminated if depression of a particular keypad button (e.g., “#” or “*” buttons 280 or 281) serves same purpose. In another embodiment, the Pickup Pause operating mode may be automatically enabled under electronic calendar program control as described in FIG. 5E.

DEACTIVATE button 291, when depressed, allows the user to selectively control the deactivation of one or more operating modes of wireless communication unit 110₁ at a scheduled time (immediately or commencing in the future). Also, it allows the user to program the reactivation of an operating mode(s) of wireless communication unit 110₁ after a prescribed period of time has elapsed. An example of the programming screens is set forth in FIGS. 5A-5M.

Referring now to FIG. 2B, a second exemplary embodiment of exterior elements of wireless communication unit 110₁ is shown. Wireless communication unit 110₁ comprises handset casing 200 featuring both front face 205 and back face 210. For this embodiment, however, front face 205 includes a MENU button 295, menu screen scroll control buttons 296 and 297, SELECT button 298, besides apertures 220, display 230, keypad 240, power button 250, and optional antenna 260.

For one embodiment, it is contemplated that both MENU and SELECT buttons 295 and 298 may be used by the user for scheduling an event for activation or deactivation of a mode of operation using a calendar program loaded within internal memory of wireless communication unit 110₁ as described in FIGS. 5A-5M. In the alternative, menu screen scroll control buttons 296 and 297 may be used for calendar scheduling.

B. Exemplary Internal Logic Architecture

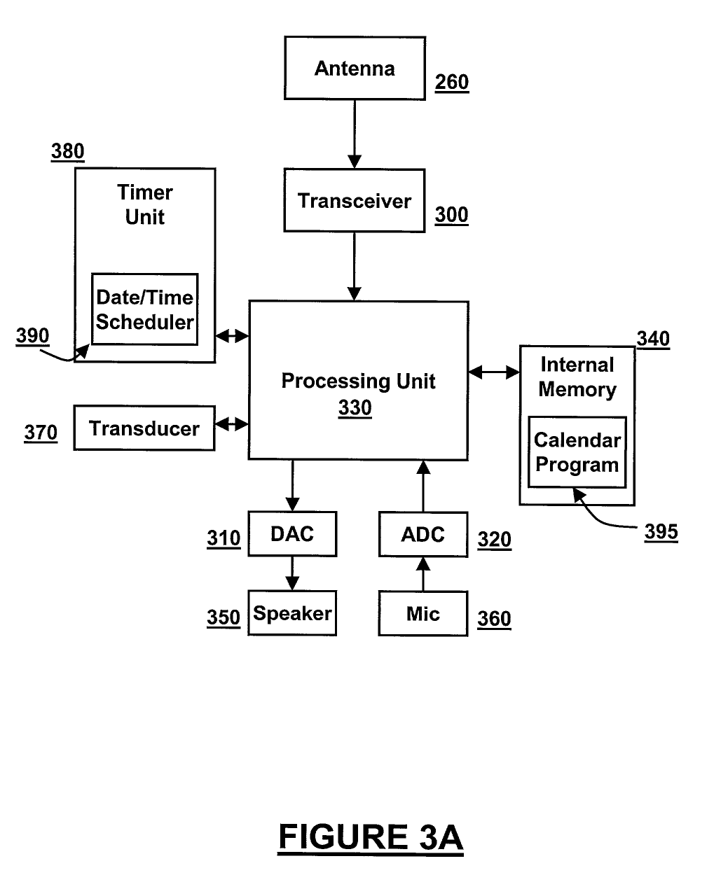

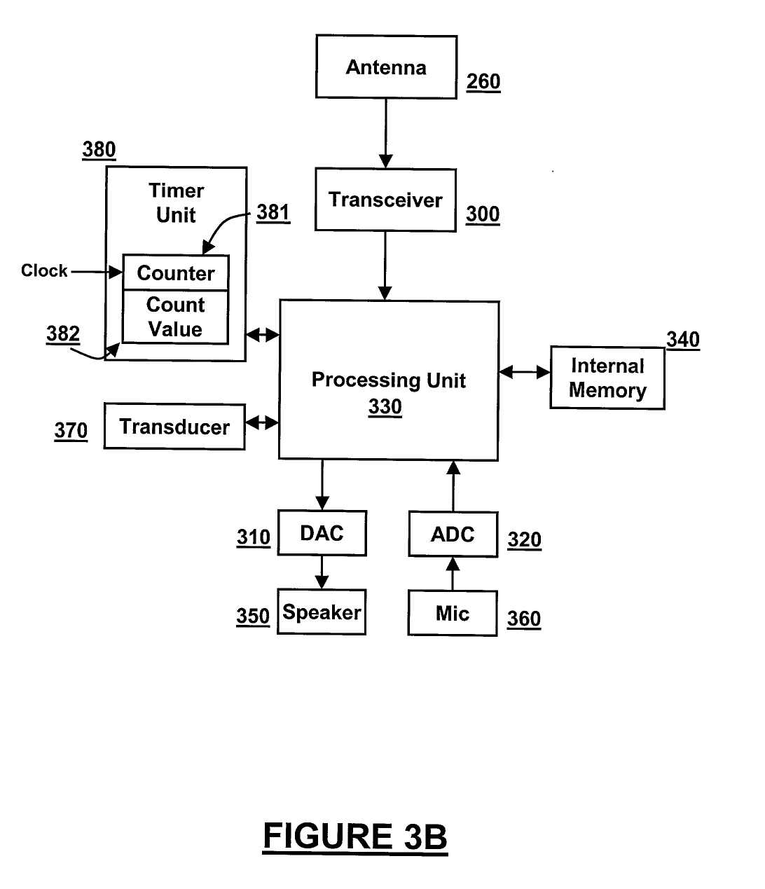

Referring to FIG. 3A, a first exemplary embodiment of internal logic of wireless communication unit 110 is shown. Wireless communication unit 110₁ comprises a transceiver 300, a digital-to-analog converter (DAC) 310, an analog-to-digital converter (ADC) 320, a processing unit 330, an internal memory 340, a speaker 350, a microphone 360 and a timer unit 380. As an option, wireless communication unit 110₁ may further include a vibration device (e.g., transducer 370) if it supports a “silent-ring” (or vibration) feature.

For one embodiment, timer unit 380 includes a date/time scheduler 390 that periodically accesses the internal clock and date maintained by wireless communication unit 110₁. Generally operating with an electronic calendar program 395, date/time scheduler 390 may be configured as hardware, firmware, software or any combination thereof. The latter two forms, namely firmware or software, are executed by processing unit 330 and, as software, date/time scheduler 390 is stored in internal memory 340. Date/time scheduler 390 is responsible for placing wireless communication unit 110₁ into one of a plurality of operating modes based on scheduled events. Some of these operating modes may include (i) Pickup Pause, (ii) temporary Power-Off, (iii) temporary Suspend Power-Off, or even audible or vibratory ring modes.

Timer unit 380 may be programmable by the user and is powered by battery 215 of FIGS. 2A and 2B or, when battery power is disrupted, from an internal power source (e.g., a Lithium battery, Nickel-based battery, or capacitor). The internal power source may be rechargeable by battery 215.

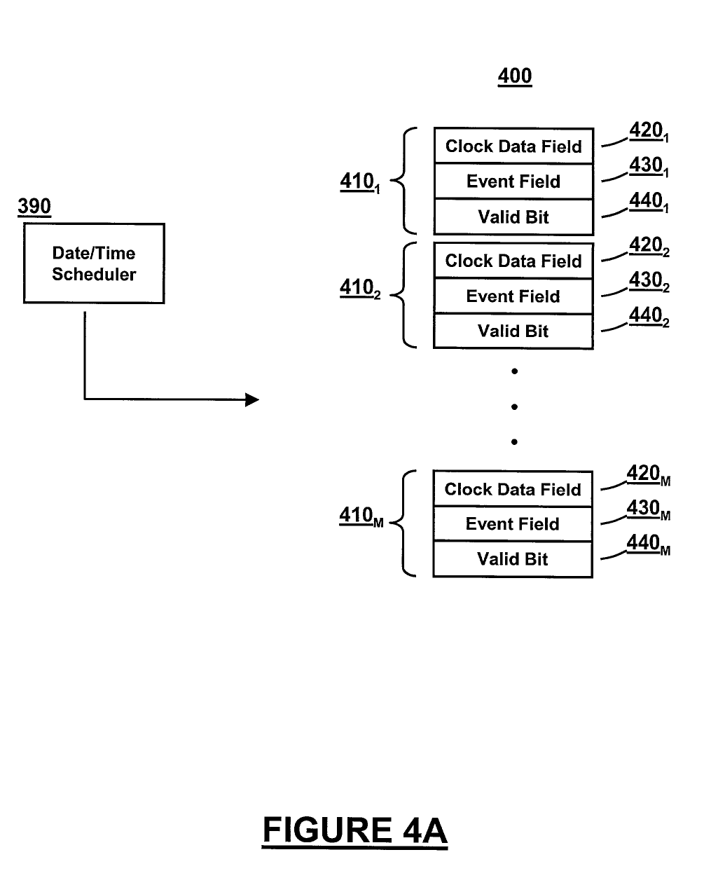

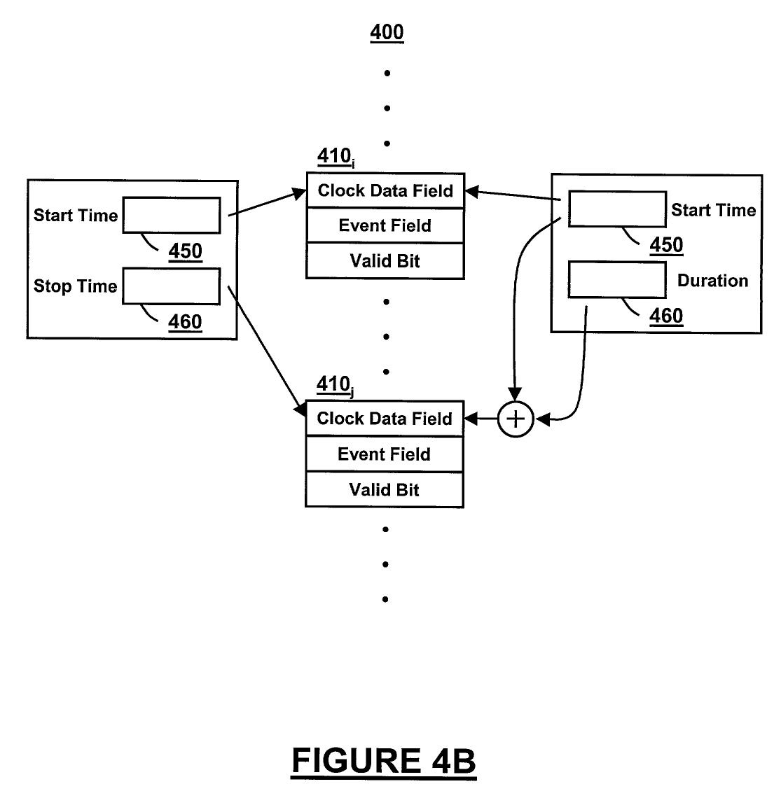

Referring now to FIGS. 4A-4B, exemplary operations of date/time scheduler 390 loaded into internal memory 340 to control activation and/or deactivation of various operating modes of wireless communication unit 110₁ are shown. Date/time scheduler 390 is executed by processing unit 330 to ascertain upcoming events placed in calendar program 395 of wireless communication unit 110₁ (see FIG. 3A).

In one embodiment, as shown in FIG. 4A, date/time scheduler 390 periodically accesses one or more queues 400 stored in internal memory 340, where each entry 410₁-410_{M} (M≧1) of queue 400 includes (1) clock data field 420₁-420_{M}, and/or (2) an event field 430₁-430_{M}. Also, each entry 410₁, . . . , 410_{M} may include a valid bit 440₁-440ₘ, respectively.

The “clock data” may include a calendar date and/or one or more time values (e.g., start time and/or end time). The “event type” identifies the type of event programmed by the user via a calendar program. For one embodiment, the event type may be represented as code recognized by date/time scheduler 390 to indicate an event to be performed by the wireless communication unit 110₁. For example, one event may involve wireless communication unit 110₁ entering into a Power-Off mode at a certain time. Another event may involve wireless communication unit 110₁ entering into a Suspend Power-Off mode. Yet another event may be to return to a normal operating mode.

Date/time scheduler 390 determines the next upcoming, chronologically scheduled event by analyzing contents of the clock data fields 420₁-420_{M} within entries 410₁-410_{M} of the queue(s) 400. Alternatively, the queue(s) 400 may be arranged chronologically with the next upcoming scheduled event in the most significant entry 410₁ or least significant entry 410_{M}. The event start time (and perhaps date) associated with the next upcoming scheduled event (e.g., clock data contents of entry 410₁) is compared to the current clock value (time and perhaps date).

If a match is detected, the wireless communication unit 110₁ performs an operation associated with that event. For instance, the event may require wireless communication unit 110₁ to temporarily enter into a Power-Off mode. Thereafter, entry 410₁ is subsequently cleared or tagged as invalid by clearing its valid bit 440₁. Date/time scheduler 390 continues comparing the internal clock values with valid entries 410₂-410_{M} until other activities are detected (e.g., Power Resume event to discontinue the Power-Off mode and return to a Power-On mode).

As shown in FIG. 4B, in response to a user either entering a start time 450 and stop time 460 associated with an event or selecting the time frame through menu options, the calendar program produces two entries—a start event entry 410i having the start time 450 and event type and an end event entry 410j including a stop time 460 and event type. Of course, instead of a stop time 460 being programmed by the user, a time duration 470 may be entered with the stop time computed by adding that time duration 470 to the start time 450.

For events that are scheduled to happen immediately, the calendar program loads the current time (with perhaps a short delay) as the start time with the programmed or computed stop time for placement into the end event entry. Then, the date/time scheduler is signaled to access the queue.

Referring back to FIG. 3B, a second exemplary embodiment of internal logic of wireless communication unit 110₁ is shown. Wireless communication unit 110₁ comprises transceiver 300, DAC 310, ADC 320, processing unit 330, internal memory 340, speaker 350, microphone 360 and optional transducer 370 as shown in FIG. 3A. However, for this embodiment, timer unit 380 is configured in another configuration.

Herein, time unit 380 includes a counter 381 assigned with a count value 382 corresponding to a desired period of time. The count value 382 may be programmed by the user or selected by the user from one or more pre-programmed time periods. After loaded with count value 382, counter 381 begins counting until count value 382 is equal to a predetermined value (e.g., zero for a decremental counter, a positive value for an incremental or monotonic counter, etc). The desired period of time normally elapses upon counter 381 reaching count value 382.

Counter 381 may be clocked by an internal clock source (referred to herein as “CLK”) such as a dedicated clock source (e.g., crystal oscillator) or a common clock source (e.g. clock used by processing unit 330 or another component of wireless communication unit 110₁). Of course, counter 381 may be clocked or synchronized by an external clock source remotely located from wireless communication unit 110₁, perhaps via signals from a service provider via wireless transceiver 300.

Initially programmed by wireless communication unit 110₁ in a manner similar to setting up events in a computer-based electronic calendar, the time duration is entered by the user to perform an event such as deactivation and reactivation of an operating mode such as Power-Off, Suspend Power-Off and Pickup Pause. The time duration is converted to count value 382 that may represent a total number of minutes, second or portions thereof that an event is to be performed. For instance, if a two-hour duration is needed, the count value may be equal to 7200 (2×60×60), where count value 382 represents the number of seconds that wireless communication unit 110₁ is deactivated.

III. Feature Timer Functionality

Referring back to FIG. 3A, the timer unit 380 may be used to allow a user to schedule an event, namely a period of time during which a particular mode of operation will be activated, deactivated or even reactivated.

Employed within wireless communication unit 110₁ as shown in FIG. 3A, timer unit 380 operates in cooperation with processing unit 330 to control the activation and/or deactivation of certain operating modes. For one embodiment, when the user has to enter into a sensitive environment where audible interruptions are inappropriate, wireless communication unit 110₁ should be placed in a Power-Off mode, a Suspend Power-Off mode, Pickup Pause mode or even an alternative ring type (e.g., a silent ring call notification mode). Such events could be programmed into wireless communication unit 110₁ in a way similar to setting up events in a computer-based electronic calendar as shown in FIGS. 5A-5M.

For instance, the user may place wireless communication unit 110 in a Power-Off mode during which wireless communication unit 110₁ behaves as if it is turned off (fails to receive any signals). Alternatively, wireless communication unit 110₁ may be placed in a Suspend Power-Off mode where that unit 110₁ receives signals but does not respond to such signals. Also, wireless communication unit 110₁ may enter into a silent ring call notification mode (referred to as “Silent Ring” mode) in lieu of an audible call notification mode (referred to as “Audible Ring” mode).

In particular, during Power-Off mode, wireless communication unit 110₁ does not receive any incoming calls and, as an option, notifies its service provider to playback a recorded message in response to each incoming call received for wireless communication unit 110₁. The message may indicate to the caller when the temporary Power-Off mode is scheduled to elapse. The duration for this temporary Power-Off mode may be communicated by the wireless communication unit 110₁ to the service provider prior to successfully entering into its Power-Off mode.

As an alternative to or complementary with a recorded message, it is contemplated that an alphanumeric message may be sent to the caller to indicate that the wireless communication unit of the intended recipient is in Power-Off mode and perhaps when the temporary Power-Off mode is scheduled to elapse.

When the desired Power-Off time period has expired, wireless communication unit 110₁ may automatically reactivate and returns to its normal operating mode. As a result, the service provider either (i) detects that wireless communication unit 110₁ is now capable of receiving signals and discontinues message playback to subsequent callers or (ii) is notified directly by wireless communication unit 110₁.

Upon entering into a Suspend Power-Off mode, wireless communication unit 110₁ continues to receive incoming calls but does not process such calls. Optionally, wireless communication unit 110₁ may be adapted to play a message that indicates a temporary inability to receive calls and perhaps a scheduled time when wireless communication unit 110₁ will again be receiving incoming calls.

In another example, upon entering a symphony hall, the user may place his or her phone in Silent Ring mode for the anticipated duration of the concert. This may be accomplished by scheduling (in advance) the time at which the phone will transition to Silent Ring mode, along with an end time (or time duration) for returning to its normal Audible Ring mode. After such scheduled time period has elapsed, the phone will automatically return to its Audible Ring mode.

Referring now to FIG. 5A-5M, exemplary image screens illustrated on a display for scheduling one or more events at the wireless communication unit or service provider is shown. In response to depressing the MENU button 295 of the wireless communication unit of FIG. 2B, a first screen image 500 is displayed as shown in FIG. 5A. First screen image 500 includes a plurality of menu options, including a “Messages” menu option 502 to retrieve voice messages and a “Calendar” menu option 504 to retrieve an internally stored calendar program and schedule various events to control activation and deactivation of selected operating modes.

Referring now to FIG. 5B, an exemplary embodiment of a second screen image 510 produced in response to selection of Calendar menu option 504 is illustrated. Second screen image 510 displays a plurality of calendar options, including a “Set Date/Time” menu option 512, “Feature Timer” menu option 514, “General Schedule” menu option 516 and a “Feature Timer with Repetition” menu option 518.

“Set Date/Time” menu option 512, when selected, allows the user to reset the date and clock time recognized by the wireless communication unit. Thus, the user may be able to schedule for the occurrence of specific events in different time zones. Also, it enables the user to readjust the clock time if deemed inaccurate.

“Feature Timer” menu option 514, when selected, allows the user to schedule the occurrence of an event such as the deactivation/activation of a particular operating mode of the wireless communications unit. These event types comprise power, ringer, call handling, Pickup Pause or unit operation profiles for example.

“General Schedule” menu option 516, when selected, allows the user to schedule meetings and other activities. Such scheduling does not cause activation or deactivation of any operating modes of the wireless communication unit.

“Feature Timer with Repetition” menu option 518, when selected, allows the user to schedule the occurrence of a particular event and subsequently schedule multiple occurrences of that event at one time. This avoids the user having to reprogram regularly occurring or repeating events.

Referring to FIG. 5C, an exemplary embodiment of a third screen image 520 produced in response to selection of Feature Timer menu option 514 is illustrated. Third screen image 520 displays a representation of complete or partial calendar 522 for selecting a start date of event type of FIG. 5E. As shown, calendar 522 features a two-week interval, where the size of the interval may vary depending on the physical size of the display of the wireless communication unit. Upon selecting one of days set forth in the calendar 522 (e.g., 16^{th} day of the month), such information is loaded into a clock data field reserved for this event. Moreover, the calendar program is executed to cause a fourth screen image 530 to be produced.

Otherwise, if calendar 522 does not illustrate the desired event start date, the user may select a “next time period” field 524, which may be configured to display the next interval chronologically in a calendar format. Alternatively, selection of next time period field 524 may cause the calendar program to produce a listing of upcoming months/years to allow the user to select the particular month (or portion thereof) to be illustrated in a calendar format.

As shown in FIGS. 5D, fourth screen image 530 illustrates a plurality of event start-time menu options 532. For this embodiment, the start times are segmented according to consistent time intervals, varying time interval or a combination thereof (e.g., quarter hour, half-hour, one-hour, etc.). The organization of event start time menu options 532 may be sorted chronologically, or perhaps chronologically based on the current time so that start times that have already elapsed may not be selected.

In lieu of menu options 532, it is contemplated that fourth screen image 530 may include a field into which start time (e.g., hour and minute) may be entered. Such programming may be accomplished using the keypad of the wireless communication unit.

Referring back to FIG. 5D, as an optional feature, a higher level of time-period granularity may be provided by the calendar program producing an additional screen image 534 upon selection of one of the event start times 532. For example, upon selecting an event start-time menu option such as 1:00 P.M., screen image 534 is generated. This screen image 534 is similar to fourth screen image 530 but includes menu options 536 segmented according to a time interval of equal or lesser duration that used for fourth screen image 530.

Referring now to FIG. 5E, an exemplary embodiment of a fifth screen image 540 produced in response to completion of the event start date/time programming is illustrated. Of course, it is contemplated that the ordering of the screen images 5A-5M may be altered without departing from the spirit or scope of the invention. For example, it is contemplated that fifth screen image 540, featuring menu options corresponding to different event types, may be produced in response to selection of Feature Timer menu option 514 of second screen image 510 of FIG. 5B.

As shown, for this embodiment, fifth screen image 540 includes menu options that identify various event types corresponding to modes of operation that can be selectively deactivated and activated for a chosen time period. As shown, fifth screen image 540 comprises a “Power” menu option 542, a “Ringer” menu option 544, a “Communications Protocol” menu option 546, a “Redial” menu option 548, a “Pickup Pause” menu option 550 and a “Profile” menu option 552. Of course, Pickup Pause menu option 550 may be accessible by the user independent of Feature Timer activation.

Power menu option 542 enables the user to control deactivation and activation of the wireless communication unit. As shown in FIG. 5F, upon selection of Power menu option 542 for example, the calendar program produces a sixth screen image 560, which lists various power mode menu options. These power mode menu options include, but are not limited to, “Power-On” menu option 562, “Power-Off” menu option 564, “Suspend Power-Off” menu option 566 and “Suspend Power-On” menu option 568.

When Power-On menu option 562 is selected and this event becomes activated, the wireless communication unit operates normally by being able to receive, transmit and process signals. However, when Power-Off menu option 564 is selected and this event becomes activated, the wireless communication unit will be unable to receive, transmit or process signals of any kind.

When Suspend Power-Off menu option 568 is selected and this event becomes activated, the wireless communication unit receives but fails to process information associated with an incoming call. When Suspend Power-On menu option 566 is selected and this event becomes activated, the wireless communication unit is capable of receiving and processing incoming signals.

Referring back to FIG. 5E, the Ringer menu option 544 enables the user to control the type of ring signal output by the wireless communication unit. Upon selection of the Ringer menu option 544, a seventh screen image 570 is produced that includes menu options associated with different types of ring signals as shown in FIG. 5G. For instance, one menu option 572 may be associated with a particular type of audible ring signal while another menu option 574 may be associated with a silent ring (e.g., vibratory).

After selection, screen images are produced for setting the event duration as shown in FIGS. 5I-5L. It is contemplated, however, that prior to producing screen images for setting the event duration, screen images may be produced for controlling and setting the volume of the ringer.

Referring back to FIG. 5E, the Communication Protocol menu option 546 enables the user to activate/deactivate certain communication protocols, which provides functionality to those regions or partner service providers that support different communication protocols than normally used. After selection of the Communication Protocol menu option 546, an eighth screen menu 580 is produced that enables the user to select the type of communication protocol to be currently operable as shown in FIG. 5H. After selection, screen images are produced for setting the event duration as shown in FIGS. 5I-5L.

Referring back to FIG. 5E, according to a first embodiment, Redial menu option 548 is a mechanism that enables callers to be notified when the wireless communication unit is temporarily deactivated by the user. For instance, such notification is conducted by the service provider in response to receiving a signal from the wireless communication unit that it is temporarily entering into a Power-Off mode. In response, the service provider would automatically answer incoming calls intended for the wireless communication unit and playback messages explaining that the user is currently unavailable for “X” amount of time (where “X” represents the amount of time remaining before the wireless communication unit is scheduled to receive incoming calls). This lets the caller decide the best time to call back.

However, when the wireless communication unit is temporarily entering into a Suspend Power-Off mode as well as other operating mode besides the Power-Off mode, the service provider may be configured to answer incoming calls automatically and playback a message as described above. However, it is contemplated that the wireless communication unit itself may be adapted to answer incoming calls automatically and playback the message in the Suspend Power-Off mode and any other operating modes involving the wireless communication unit.

Alternatively, according to a second embodiment of the Redial operating mode, the wireless communication unit may be adapted to send a control signal to a telephone or communication unit of a caller (referred to as “source unit”) in response to an incoming call from the caller. The control signal enables the source unit to understand that the recipient's phone will be “out of service” for “X” amount of time and configures the source unit to automatically call back the wireless communication unit at the appropriate time, ringing both units.

Either of the Redial operating modes could avoid potentially hundreds of useless redial operations.

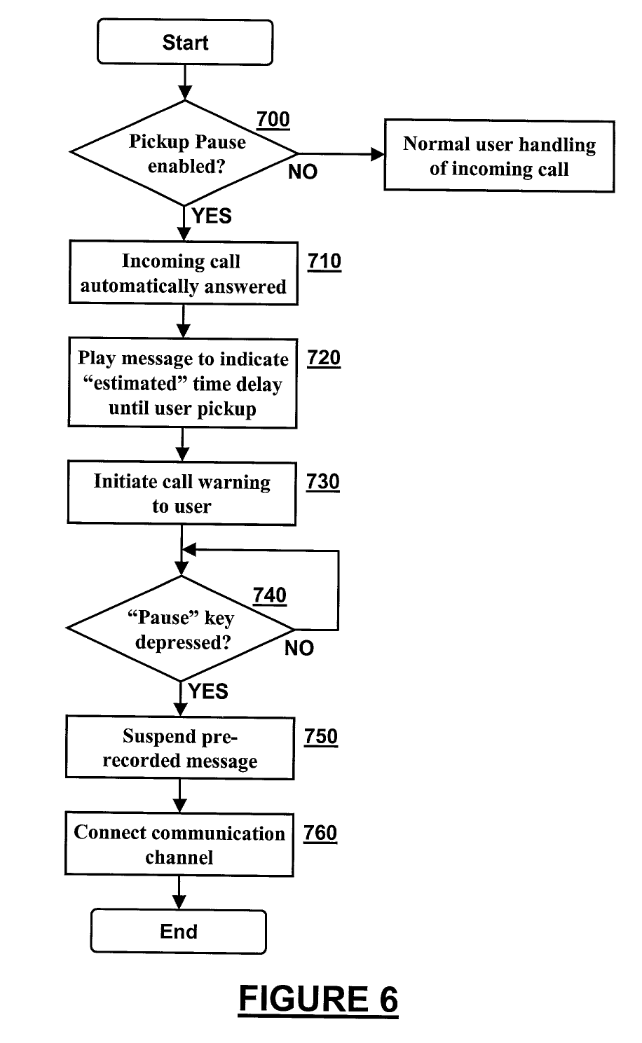

Referring still to FIG. 5E, Pickup Pause menu option 550 enables the user to activate/deactivate a pickup pause operating mode as described below in FIGS. 6-10.

Profile menu option 552 enables the user to create a profile, namely a grouping of activated and/or deactivated events. For instance, one profile may involve meetings in which the wireless communication unit has a “Silent Ring” ring type and Pickup Pause is activated. Another profile may involve outdoor environments where the volume of the ring signal is raised substantially above its normal audible level. Yet another profile may involve air travel in which the wireless communication unit is placed in a Power-Off operating mode.

Referring to FIG. 5I, an exemplary embodiment of a ninth screen image 590, which is produced in response to selection of an event and programming its start date/time, is illustrated. In one embodiment, ninth screen image 590 provides event duration options such as “Stop Time” 592, “Time Duration” 594 and “None” 596.

Stop Time menu option 592, when selected, enables the user to schedule an event to control the deactivation or reactivation of a selected mode of operation. As shown in FIG. 5J, in response to selection of Stop Time menu option 592, tenth screen image 600 displays a representation of complete or partial calendar 602 for selecting a stop date for the scheduled event. Upon selecting one of the days set forth in the calendar 602 (e.g., the 30^{th} day of the month), such information is loaded into a clock data field reserved for this event. Also, the calendar program causes an eleventh screen image 610 to be produced.

Otherwise, if calendar 602 does not illustrate the desired event stop date, the user may select a next time interval field 604, which may be configured to display the next interval chronologically in a calendar format. Alternatively, selection of next time interval field 604 may cause the calendar program to produce a listing of upcoming months/years to allow the user to select the particular month (or portion thereof) to be illustrated in a calendar format.

As shown in FIG. 5K, twelfth screen image 610 illustrates a plurality of event stop-time menu options 612. Similar to FIG. 5D, the stop times are segmented according to consistent time intervals, varying time interval or a combination thereof. These stop time menu options 612 may be sorted chronologically, or perhaps chronologically based on the current time recognized by the wireless communication unit.

In lieu of menu options 612, although not shown, it is contemplated that screen image 610 may include a field into which a stop may be entered. Such programming may be accomplished using the keypad of the wireless communication unit.

As an optional feature, a higher level of time-period granularity may be provided by an additional screen image 614 upon selection of one of the event start times 612. For example, upon selecting a start-time menu option such as 3:00 P.M., screen image 614 is generated. This screen image 614 is similar to screen image 610 but includes menu options 616 segmented according to a time interval of equal or lesser duration that used for screen image 610.

Time Duration menu option 594, when selected, enables the user to enter the duration of activation or deactivation of the operating mode. As shown in FIG. 5L, in response to selection of Time Duration menu option 594, a thirteenth screen image 620 is produced. Screen image 620 includes a field 622 into which the duration of the scheduled event may be entered. Such programming may be accomplished using the keypad of the wireless communication unit. The duration may comprise (i) number of days, (ii) number of hours, and/or (iii) number of minutes.

None menu option 596, when selected, indicates that the scheduled event is to continue until programmed by the user to discontinue.

Upon selecting the “Feature Timer with Repetition” menu option 518 of FIG. 5B and completion in scheduling an event, a screen image 630 of FIG. 5M is produced. Screen image 630 comprises a plurality of menu options 632-640, which enable the user to select whether the event programmed will be repeated daily, weekly, monthly, annually or randomly as selected by the user.

For instance, by selecting one of the menu options 632-638, additional start and end times will be programmed into the queue for handling additional scheduled events that occur each day, week, month or year after the first scheduled event. However, by selecting the “Random Selection” menu option 640, a screen image displaying a representation of a complete or partial calendar is produced by the calendar program. Upon selecting a day set forth in the calendar representation, the event type, start and stop times equivalent to the first scheduled event are routed to the queue. As a result, another scheduled event, at the same time as the first scheduled event, is easily programmed.

IV. Pickup Pause Functionality

A. Pickup Pause Feature

Referring to both FIGS. 3A and 3B, transceiver 300 is coupled to antenna 260 in order to receive wireless signals and transfer these wireless signals to processing unit 330. Processing unit 330, under control of a program loaded within internal memory 340 (e.g., non-volatile memory), may perform one of a plurality of operations.

In general, one operation, performed on receipt of an incoming call, involves an initial determination whether the Pickup Pause operating mode has been enabled. If so, an automated message is transmitted from wireless communication unit 110₁ back to the caller to indicate that the user cannot immediately answer the incoming call. Concurrently, processing unit 330 generates a perceivable warning to the user that such incoming call has been received. In one embodiment, this warning may be accomplished through activation of transducer 370, which causes wireless communication unit 110₁ to vibrate. Another alternative or a complementary type of warning includes an alphanumeric message. Yet another alternative or complementary type of warning includes audible, programmable ringer tones for a sensitive environment, where the ringer tones are of a short duration (e.g., less than one second). This tone may be a singular or periodic in nature.

Any one or more of these warnings allows the user to gracefully extricate himself or herself from a sensitive environment (e.g., private or public gathering where answering an incoming call would cause unwanted disruption) without having to immediately answer the cellular telephone call or rush out of the sensitive environment for fear that the caller will hang-up.

Another operation involves processing unit 330 generating the perceivable warning of an incoming call as described above. A recorded message (e.g., pre-recorded) is activated and communicated back to the caller in response to the user depressing a particular button of the wireless communication unit 110₁ if desired. The particular button may be PAUSE button or even the “#” or “*” button instead of the TALK button.

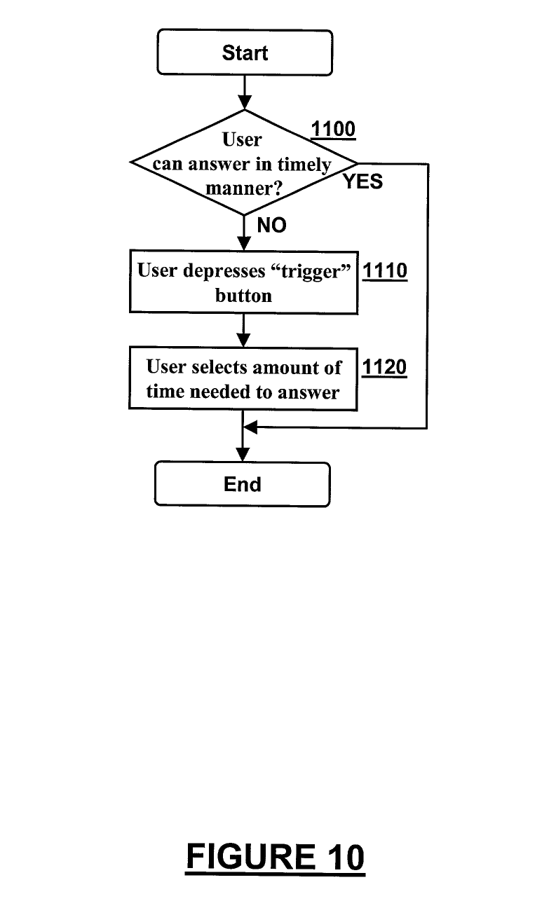

Referring to FIG. 6, a first exemplary flowchart of the Pickup Pause feature is shown. When the Pickup Pause feature is enabled and placed in an Automatic mode, the incoming call is automatically answered with a message (e.g., a recorded message) that indicates to the caller that the recipient is currently in a “sensitive” environment and cannot immediately answer the call (blocks 700 and 710). The answering of the incoming call and playback of the recorded message occurs prior to or coincident with providing a perceivable warning of an incoming call to the recipient. As an option, the recorded message may indicate the “estimated” pickup time delay before the user will answer the call (block 720). This estimated time delay may be preprogrammed by the user or entered on the fly (see FIG. 10). For this embodiment, the recorded message is only audible to the caller and, therefore, does not disturb those in the vicinity of the user's wireless communication unit. Furthermore, audio capture by the user's wireless communication unit is not propagated to the caller's unit, thus preventing inadvertent eavesdropping on conversations occurring in the sensitive environment.

After answering of the incoming call and playback of the recorded message, a sufficiently perceivable warning is produced to alert the user to the incoming call (block 730). It is contemplated that the perceivable warning may be a Ring signal or another type of signal provided by the service provider. Once the user has moved to a non-sensitive environment, he or she completes the wireless connection by pressing the particular button such as the PAUSE button or the “#” button for example (block 740). This suspends the recorded message (if still in operation) and connects the communication channel (blocks 750 and 760).

As an alternative to or complementary with a recorded message, it is contemplated that an alphanumeric message may be sent to the caller to indicate that the intended recipient requires time before he or she can answer the incoming call.

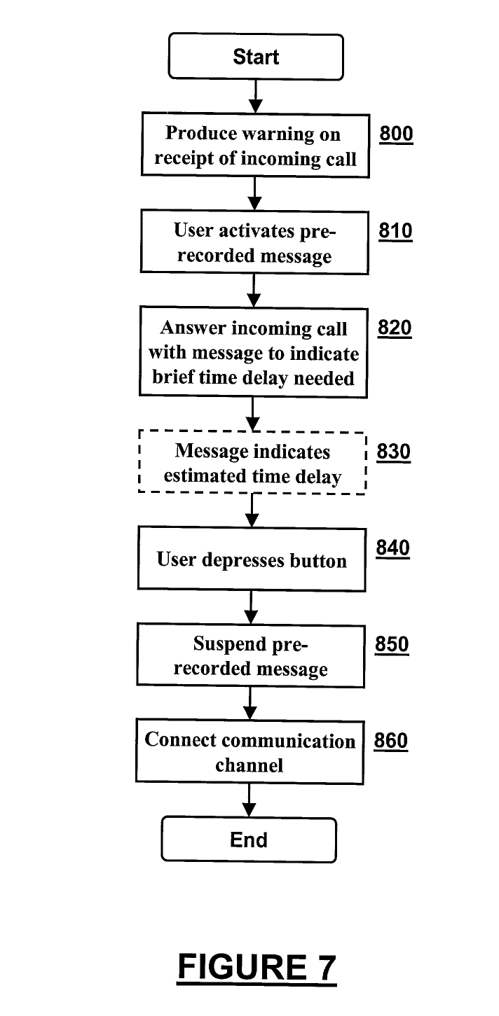

Referring now to FIG. 7, a second exemplary flowchart of the Pickup Pause feature is shown. The Pickup Pause feature for the wireless communication unit is enabled and placed in a Manual mode. Upon receiving an incoming call, the wireless communication unit produces a perceivable warning to alert the user to the incoming call (block 800). In response to perceiving the warning, the user may explicitly activate or trigger the recorded message for the incoming call as desired (block 810). One activation technique is for the call recipient to select a particular button (e.g., a dedicated PAUSE button or simultaneous or sequential activation of one or more traditional buttons such as the “#” or “*” buttons).

If the recorded message is activated, the incoming call is answered with a recorded message that indicates to the caller that the recipient is currently in a sensitive environment and will require a brief time delay before the call can be answered (block 820). As an option, the recorded message may indicate an estimation of the time delay before the user will answer the call as described above (block 830). Similarly, the recorded message is solely audible to the caller and no other audio at the user's wireless communication unit environment is propagated to the caller's unit.

Once the user has moved to a non-sensitive environment, he or she completes the wireless connection by pressing the particular button or even a different button (block 840). This suspends the recorded message (if still in operation) and connects the communication channel (blocks 850 and 860).

With respect to the Pickup Pause feature of FIGS. 6 and 7, this functionality may be implemented entirely within the communication unit (e.g., handset) itself with no change to the existing service provider's infrastructure. The recorded message would reside in internal memory and the Pickup Pause feature would be directly controlled by the processing unit based on selections by the call recipient (user).

However, it is contemplated that the Pickup Pause feature may be offered as an optional service by a service provider (e.g. cell phone service company), with potentially no modification to the wireless communication unit itself. In one embodiment, a special call to the service provider could enable the Pickup Pause feature. Other Pickup Pause enablement techniques may be accomplished through different communication pathways such as by the user accessing a web site of the service provider.

When the Pickup Pause feature is enabled and placed in a first mode, the service provider would playback a message to the caller indicating that the recipient is unavailable to answer the call prior to or concurrent with notification of the recipient of the call. When the Pickup Pause feature is enabled and placed in a second mode, the user could answer the wireless communication unit normally, but immediately push one or more selected keys (perhaps with the SEND key) to output values (e.g., digital code, analog waveform, etc.) as content for a control signal to the service provider to trigger the playback of a message. While the service provider would continue to receive audio information from the recipient's wireless communication unit, this audio signal would not be passed through to the caller until the recipient had indicated his desire to complete the connection as described above (again, perhaps with a second push of the PAUSE button, “#” button or some other button). This allows the recipient to extricate himself or herself from a potentially sensitive location without concern that the audio from such environment be inadvertently received by the caller.

B. Other Pickup Pause Related Enhancements

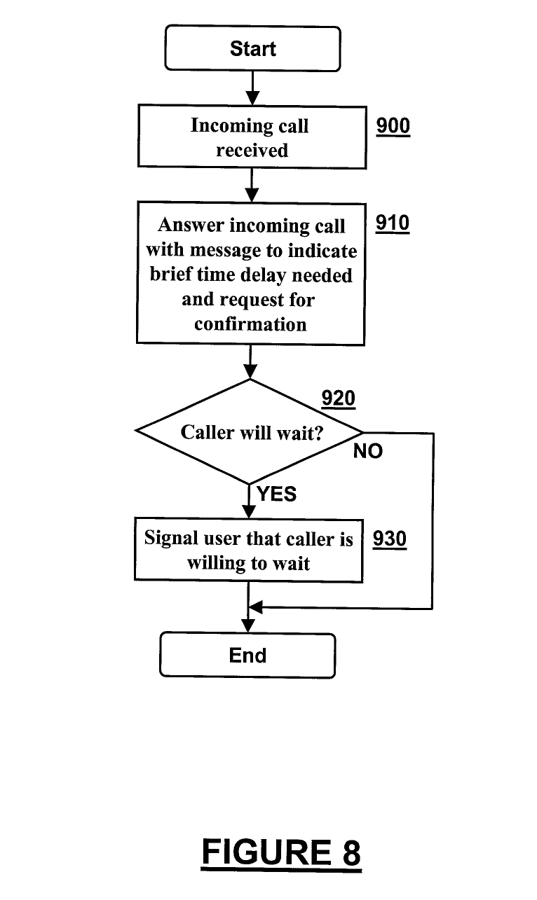

Referring now to FIG. 8, an exemplary flowchart describing a first enhancement of the Pickup Pause feature is shown. In response to receiving an incoming call, either automatically or at the recipient's express selection, the incoming call is answered with a recorded message indicating a delay in answering the call along with a confirmation request (blocks 900 and 910). The confirmation request requires the caller to indicate whether he or she would be willing to wait for the recipient to complete the connection. For example, the recorded message might state the following:

“The intended recipient cannot immediately pickup this call, but will do so in approximately thirty (30) seconds—do you wish to wait? If so, please press the # key.”

In this case, the recipient could see right away through a signal received by his wireless communication unit whether the caller was willing to wait for the stated duration (blocks 920 and 930). If no response is provided by the caller, the incoming call is transferred to voicemail, which allows the caller to leave a verbal message.

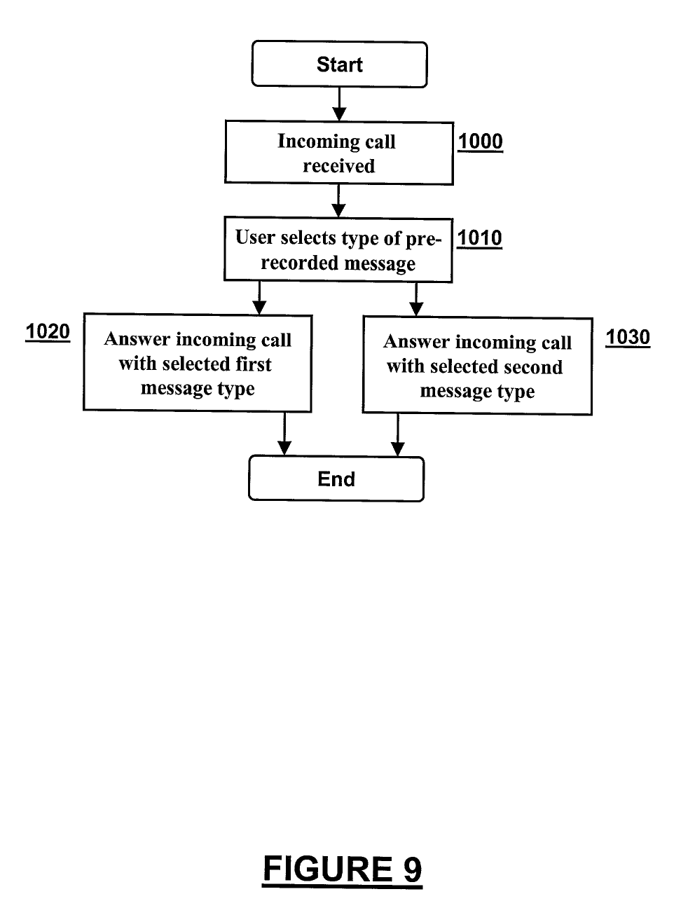

Referring now to FIG. 9, an exemplary flowchart describing a second enhancement of the Pickup Pause feature is shown. In response to receiving an incoming call, the recipient may be able to select any of a plurality of recorded message options (blocks 1000 and 1010). Such selection may occur at the time of the incoming call. For example, as shown in block 1020, the recipient might select a first message type that indicates a shorter time delay (e.g., thirty seconds) for a small meeting with co-workers (where its quick and easy to duck out). Alternatively, as shown in block 1030, the recipient may select a second message type that indicates a longer time delay (one minute or longer) for a client meeting or public gathering such as a symphony (where picking up would undoubtedly take much longer).

Referring now to FIG. 10, an exemplary flowchart describing a third enhancement of the Pickup Pause feature is shown. In a continuously changing environment, the recipient may realize that he or she would not be able to answer the incoming call within the prescribed time delay (block 1100). If so, the recipient can depress a particular trigger button (e.g. the “*” key) to explicitly cause an alternative message to be played to the caller (block 1110). As an alternative or complementary enhancement, upon depressing the particular trigger button, the user may now program the duration of delay by subsequently depressing a numerical button (0-9) or a combination of numerical buttons (00-99) to indicate minutes or seconds of additional delay as shown in block 1120.

A fourth enhancement allows the user to program an amount of time (or select a preprogrammed amount of time) during which the Pickup Pause feature (whether provided by the wireless communication unit or a service provider) will be active. For example, upon entering a one-hour meeting, the user could select “Pickup Pause” and the time duration “1 hour” so that the Pickup Pause function would be active for the duration of the meeting. Such duration may be controlled by timer unit 380 of FIG. 3B. At the end of the one-hour period, the Pickup Pause feature is automatically disengaged (by the phone or service provider), thereby relieving the user of the burden of remembering to disengage the mode of operation.

In one instance, the Pickup Pause feature may be provided by software loaded into machine-readable medium (e.g., internal memory) of the wireless communication unit and executed by the processing unit. The user activates the Pickup Pause feature by accessing a scroll-down menu and selecting this mode of operation. Thereafter, a secondary menu is displayed on the display to allow the user to either select the amount of pause time or enter the amount of time via the keypad.

In another instance, the Pickup Pause feature may be provided by contacting the service provider through a telephone call or an alphanumeric message from the wireless communication unit.

Those skilled in the art will recognize that the wireless communication unit and method of the invention have many applications, and that the invention is not limited to the representative examples disclosed herein.

What is claimed is:

1. A wireless communications unit comprising:
a casing having a front face;
a display; and
internal logic contained within the casing, the internal logic including a date/time scheduler to control activation and deactivation of a plurality of operating modes of the wireless communication unit.

2. The wireless communication unit of claim 1, wherein at least two of the plurality of operating modes includes a (1) Power-Off mode where the wireless communication unit is configured to neither transmit signals nor receives or process information associated with an incoming call, and (2) a Suspend Power-Off mode where the wireless communication unit is configured to receive the incoming call and prohibit transmitting signals.

3. The wireless communication unit of claim 1, wherein one of the plurality of operating modes includes a ringer mode to control a type of ring signal output by the wireless communication unit.

4. The wireless communication unit of claim 3, wherein one of the plurality of operating modes includes a mode to activate and deactivate certain communication protocols including at least one of GSM, CDMA and 3G.

5. The wireless communication unit of claim 1, wherein one of the plurality of operating modes includes a Pickup Pause mode where an incoming call is automatically answered with a playback of a recorded message generally coincident with providing a perceivable warning of the incoming call to a user of the wireless communication unit.

6. The wireless communication unit of claim 5, wherein the playback of the message indicates an estimated amount of time delay needed before the user can accept the incoming call, the amount of time delay is programmed by the user.

7. The wireless communication unit of claim 1, wherein the internal logic further includes a processing unit coupled to a memory and a transceiver, the memory storing the date/time scheduler.

8. A method comprising:
accessing a calendar program within a wireless communication unit; and
scheduling an occurrence of a first event using the calendar program to deactivate a first operating mode of the wireless communication unit for a specified period of time.

9. The method of claim 8, wherein the wireless communication unit is a cellular telephone including a display and a plurality of buttons including a keypad.

10. The method of claim 8 further comprising scheduling an occurrence of a second event using the calendar program to activate a second operating mode of the wireless communication unit for a specified period of time.

11. The method of claim 8 further comprising scheduling a subsequent occurrence of the first event using the calendar program to activate the first operating mode of the wireless communication unit.

12. The method of claim 9, wherein the accessing of the calendar program includes generating a representation of at least a partial calendar for illustration on the display.

13. The method of claim 12, wherein the scheduling of the occurrence of the first event using the calendar program includes selecting one of a plurality of days associated with the representation of at least the partial calendar to produce a screen image including a plurality of event start-time and selecting one of the plurality of event start-time.

14. The method of claim 13 further comprising scheduling multiple occurrences of the first event at different days than the one of the plurality of days without scheduling each occurrence separately.

15. The method of claim 12, wherein the scheduling of the occurrence of the first event using the calendar program includes selecting one of a plurality of days associated with the representation of at least the partial calendar to produce a screen image including a field for user entry of a start time of the deactivation of the operating mode by the user through depression of the plurality of buttons.

16. The method of claim 12, wherein the scheduling of the occurrence of the first event using the calendar program further includes selecting the first event being associated with at least one of operating modes including power mode, ringer mode, communication protocol mode, pickup pause mode and redial mode.

17. The method of claim 16, wherein the power mode includes (1) a Power-Off mode where the cellular telephone is configured to neither transmit signals nor receive an incoming call, and (2) a Suspend Power-Off mode where the cellular telephone is configured to receive the incoming call but unable to transmit.

18. The method of claim 16, wherein the redial mode enables the cellular telephone to notify a source to an incoming call of an amount of time that the cellular telephone is in the Suspend Power-Off mode.

19. The method of claim 16, where the communication protocol mode enables a user to select one of a plurality of communication protocols supported by the cellular telephone, the plurality of communication protocols including at least two of GSM, CDMA and 3G.

20. The method of claim 16, wherein the Pickup Pause mode enables an incoming call to be automatically answered with a playback of a recorded message generally coincident with providing a perceivable warning of the incoming call to a user of the cellular telephone.

21. Embodied within a machine-readable medium executed by a processing unit, a software comprising:
a first module to access a calendar program within a wireless communication unit; and
a second module to schedule an occurrence of a first event using the calendar program to at least perform one of (i) deactivating an operating mode of the wireless communication unit for a first period of time and (ii) activating the operating mode of the wireless communication unit for a second period of time.

22. The software of claim 21, wherein the machine-readable medium being contained within a cellular telephone.
